(19) United States
(12) Patent Application Publication
(10) Pub. No.: US 2026/0280052 A1
(43) Pub. Date: Sep. 17, 2026

(54) RECHARGEABLE LITHIUM BATTERIES

(71) Applicant: SAMSUNG SDI CO., LTD., Yongin-si (KR)

(72) Inventors: Mingyu JUNG, Yongin-si (KR); Junghyun LEE, Yongin-si (KR); Jeongyi PARK, Yongin-si (KR); Hyemin PARK, Yongin-si (KR); Giwook LEE, Yongin-si (KR)

(73) Assignee: SAMSUNG SDI CO., LTD., Yongin-si (KR)

(21) Appl. No.: 19/555,561

(22) Filed: Mar. 3, 2026

(30) Foreign Application Priority Data
Mar. 13, 2025 (KR) 10-2025-0032957

(51) Int. Cl. H01M 50/474; H01M 10/052; H01M 50/483; H01M 50/486

(52) U.S. Cl. CPC H01M 50/474; H01M 10/052; H01M 50/483; H01M 50/486

(57) ABSTRACT

Disclosed is a rechargeable lithium battery, including an electrode current collector, a tab portion extending from the electrode current collector, an electrode active material layer on the electrode current collector, and an insulation layer on the tab portion. The insulation layer includes a binder and an inorganic filler, and the binder includes at least one of polyimide, polyamide, or a combination thereof.

### CROSS-REFERENCE TO RELATED APPLICATION

This application claims priority to Korean Patent Application No. 10-2025-0032957 filed with the Korean Intellectual Property Office on Mar. 13, 2025, the entire contents of which are incorporated herein by reference.

### BACKGROUND

### 1. Field

Rechargeable lithium batteries are disclosed.

### 2. Description of the Related Art

A portable information device such as, e.g., a cell phone, a laptop, smart phone, and the like, or an electric vehicle, typically use a rechargeable lithium battery having high energy density and easy portability as a driving power source. Accordingly, a rechargeable lithium battery with high energy density as a driving power source or power storage power source for hybrid or electric vehicles may be advantageous.

Rechargeable lithium batteries include a positive electrode and a negative electrode including an active material capable of intercalating and deintercalating lithium ions, and an electrolyte solution, and electrical energy is produced through oxidation and reduction reactions when lithium ions are intercalated/deintercalated from the positive electrode and negative electrode.

Transition metal compounds such as, e.g., at least one of lithium cobalt-based oxide, lithium nickel-based oxide, and lithium manganese-based oxide, are typically used as positive electrode active materials for rechargeable lithium batteries, and crystalline carbon materials such as natural graphite or artificial graphite or amorphous carbon materials are typically used as negative electrode active materials.

### SUMMARY

Some example embodiments include a rechargeable lithium battery that forms an insulation layer on a tab portion extending from an electrode current collector, substantially uniformly distributes internal stress included in the insulation layer to reduce or prevent curling, thereby reducing or suppressing the occurrence of burrs when a plate is punched, and thus improving stability.

Some example embodiments include a rechargeable lithium battery including an electrode current collector, a tab portion extending from the electrode current collector, an electrode active material layer on the electrode current collector, and an insulation layer on the tab portion. The insulation layer includes a binder and an inorganic filler, and the binder includes polyimide, polyamide, or a combination thereof.

Some example embodiments include a rechargeable lithium battery that forms an insulation layer on a tab portion extending from an electrode current collector, substantially uniformly distributes internal stress included in the insulation layer to reduce or prevent curling, thereby reducing or suppressing the occurrence of burrs when a plate is punched, thereby improving stability.

### BRIEF DESCRIPTION OF THE DRAWINGS

FIG. 1 to FIG. 4 are views schematically showing rechargeable lithium batteries according to some example embodiments.

FIG. 5 is an image of a cross-section of the positive electrode manufactured in Example 1 taken using a scanning electron microscope (SEM).

FIG. 6 is an image of a cross-section of the positive electrode manufactured in Comparative Example 1 taken using a scanning electron microscope (SEM).

FIG. 7 is an image result of a circular sample of the positive electrode manufactured in Example 2 after heat treatment by cutting the sample in a cross shape in the center to evaluate the curl occurrence level.

FIG. 8 is an image result of a circular sample of the positive electrode manufactured in Example 3 after heat treatment by cutting the sample in a cross shape in the center to evaluate the curl occurrence level.

FIG. 9 is an image result of a circular sample of the positive electrode manufactured in Example 4 after heat treatment by cutting the sample in a cross shape in the center to evaluate the curl occurrence level.

FIG. 10 is an image result of a circular sample of the positive electrode manufactured in Example 5 after heat treatment by cutting the sample in a cross shape in the center to evaluate the curl occurrence level.

FIG. 11 is an image result of a circular sample of the positive electrode manufactured in Example 6 after heat treatment by cutting the sample in a cross shape in the center to evaluate the curl occurrence level.

FIG. 12 is an image result of a circular sample of the positive electrode manufactured in Example 1 after heat treatment by cutting the sample in a cross shape in the center to evaluate the curl occurrence level.

FIG. 13 is an image result of a circular sample of the positive electrode manufactured in Example 3 after heat treatment by cutting the sample in a cross shape in the center to evaluate the curl occurrence level.

FIG. 14 is an image result of a circular sample of the positive electrode manufactured in Example 7 after heat treatment by cutting the sample in a cross shape in the center to evaluate the curl occurrence level.

FIG. 15 is an image result after heat treatment to evaluate the level of curling for a circular sample manufactured by coating and drying the composition for an insulation layer prepared in Example 3 on aluminum foil.

FIG. 16 is an image result after heat treatment to evaluate the level of curling for a circular sample manufactured by coating and drying the composition for an insulation layer prepared in Example 8 on aluminum foil.

FIG. 17 is an image result after heat treatment to evaluate the level of curling for a circular sample manufactured by coating and drying the composition for an insulation layer prepared in Comparative Example 2 on aluminum foil.

FIG. 18 shows the results of analyzing the particle size distribution of the compositions for an insulation layer manufactured in Reference Examples 2, 3, and 9.

FIG. 19 is an image of a notch formed by punching to form a tab portion in Example 1.

### DETAILED DESCRIPTION

Hereinafter, example embodiments are described in detail so that the people of ordinary skill in the art can readily implement the example embodiments. However, this disclosure may be embodied in many different forms and is not construed as limited to the example embodiments set forth herein.

The terminology used herein is used to describe example embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like, of the constituents.

In this disclosure, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, and the like, may be exaggerated for clarity, and like reference numerals designate like elements throughout the specification. It is understood that when an element such as a layer, film, region, or substrate is referred to as being “on” another element, the element can be directly on the other element, or one or more intervening elements may also be present therebetween. In contrast, when an element is referred to as being “directly on” another element, there may be no intervening elements present.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from the above. Unless otherwise defined, the average particle diameter (D₅₀) may mean the diameter of particles having a cumulative volume of 50 volume % in the particle size distribution. As used herein, when a definition is not otherwise provided, the average particle diameter (D₅₀) means a diameter of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Rechargeable Lithium Battery

Some example embodiments include a rechargeable lithium battery including an electrode current collector, a tab portion extending from the electrode current collector, an electrode active material layer on the electrode current collector, and an insulation layer on the tab portion. The insulation layer includes a binder and an inorganic filler, and the binder includes polyimide, polyamide, or a combination thereof.

During the manufacturing process of the rechargeable lithium battery, burrs may occur, when an electrode plate is punched, and these burrs may cause a short circuit between positive and negative electrodes inside the battery, which is one of the main causes of lowering stability of the battery. In particular, the burrs may more likely occur in an uncoated region of a substrate of an electrode such as the tab portion, and if (when) the electrode plate is curled, an error may occur during the punching process, which may cause the burrs within the electrode plate.

On the other hand, on the tab portion extending from the electrode current collector, an insulation layer is formed between the positive and negative electrodes in order to reduce or prevent the short circuit, wherein if (when) the insulation layer is introduced as a polymer insulation layer, because curls occur within the electrode plate during the polymer drying process, and the burrs may also occur in the electrode plate into which the polymer insulation layer is introduced, it is relevant to manage to reduce or suppress the burrs.

Accordingly, some example embodiments reduce or prevent the curl occurrence by the insulation layer on the tab portion extending from the electrode current collector to substantially uniformly disperse internal stress included in the insulation layer, and thereby also reduce or suppress the burr occurrence during the punching of the electrode plate, providing a rechargeable lithium battery capable of improving stability.

To achieve the above objectives, a rechargeable lithium battery according to some example embodiments includes an electrode current collector, an electrode active material layer on the electrode current collector, a tab portion extending from the electrode current collector, and an insulation layer on the tab portion. In some example embodiments, the insulation layer may be positioned on a side of the electrode active material layer, thereby effectively exhibiting insulation property by reducing or preventing short circuits between the positive and negative electrodes through the insulation layer on the tab portion.

The insulation layer includes a binder and an inorganic filler. Conventionally, an insulation layer including the binder alone is formed on the tab portion extending from the electrode current collector, but there may be a challenge of curl occurrence due to stress differences due to an anisotropic shape of the polymer during the drying process to form the insulation layer. In addition, if (when) the electrode plate is curled, because normal punching is impossible, abnormal punching may cause burrs. Accordingly, some example embodiments introduce the inorganic filler in addition to the binder into the insulation layer on the tab portion extending from electrode current collector to substantially uniformly disperse the binder internal stress, thereby reducing or suppressing the curl and burr occurrences of the electrode plate. In addition, the burrs on the electrode plate may in general have a size in a range of about 1 μm to about 5 μm, and accordingly, the insulation layer may in general set to have a thickness of about 5 μm or higher, wherein the thicker insulation layer, the more curls, thereby the more burrs due to the abnormal punching. However, some example embodiments, in which the inorganic filler in addition to the binder is introduced into the insulation layer, may reduce or suppress the curl and burr occurrences of the electrode plate, and also increase the thickness of the insulation layer on the tab portion extending from the electrode current collector relatively, and thus contribute to improving overall stability of the battery.

The binder included in the insulation layer includes polyimide, polyamide, or a combination thereof. In an attempt to secure the stability of conventional batteries, polyvinylidene fluoride is being considered as a binder used in the insulation layer. However, in the case of polyvinylidene fluoride, the insulation properties thereof are lower than the insulation properties of polyimide or polyamide, and thus a function thereof as an insulation layer may be insufficient, or a heat resistance thereof may be low. In addition, the polyvinylidene fluoride may present a challenge in that the polyvinylidene fluoride swells when impregnated with an electrolyte solution, which can readily cause peeling, and also has low flexibility, which increases the possibility of cracks occurring within the insulation layer during tests such as bending.

In comparison, a rechargeable lithium battery according to some example embodiments can secure better insulation property and heat resistance than polyvinylidene fluoride by using a binder with desired or improved insulation and heat resistance, such as polyimide or polyamide, in the insulation layer, thereby reducing or preventing short circuits within the battery and thus improving the stability of the battery. In addition, the rechargeable lithium battery according to some example embodiments may have the advantage of low swelling due to electrolyte solution impregnation and desired or improved flexibility, which reduces the possibility of cracks occurring during bending tests.

For example, the insulation layer may include the binder in an amount in a range of about 10 wt % to about 50 wt %, about 10 wt % to about 45 wt %, about 10 wt % to about 35 wt %, about 10 wt % to about 30 wt %, about 10 wt % to about 25 wt %, or about 10 wt % to about 20 wt %, based on 100 wt % of the total of the binder and the inorganic filler. In the above range, the effects of securing desired or improved insulation, reducing swelling during electrolyte solution impregnation, and securing desired or improved mechanical properties by adding a binder may be achieved without hindering the effect of reducing or suppressing curl and burr occurrence by adding an inorganic filler.

For example, the insulation layer may include the inorganic filler in an amount in a range of about 50 wt % to about 90 wt %, about 55 wt % to about 90 wt %, about 65 wt % to about 90 wt %, about 70 wt % to about 90 wt %, about 75 wt % to about 90 wt %, or about 80 wt % to about 90 wt %, based on 100 wt % of a total of the binder and the inorganic filler. Within the above range, the effect of reducing or suppressing curl occurrence by adding an inorganic filler may be improved without impairing the effects of securing desired or improved insulation, reducing swelling during electrolyte solution impregnation, and securing desired or improved mechanical properties by adding a binder, thereby improving the punching accuracy and effectively reducing or suppressing burr generation.

For example, the insulation layer may be formed on one surface of the tab portion, or may be formed on both surfaces of the tab portion. A thickness of the insulation layer may be in a range of about 5 μm to about 30 μm, about 5 μm to about 28 μm, about 5 μm to about 25 μm, about 10 μm to about 25 μm, about 15 μm to about 25 μm, about 5 μm to about 20 μm, about 10 μm to about 20 μm, or about 12 μm to about 18 μm. Within the above range, high insulation may be secured, and at the same time, the occurrence of curls and burrs in the insulation layer may be effectively reduced or suppressed. For example, the thickness of the insulation layer may be measured by measuring the thickness of the insulation layer formed on one surface of the tab portion, and as the thickness of the insulation layer increases, the tendency for curling to occur increases, and the possibility of burrs occurring due to abnormal punching increases, so that precise control of the characteristics of the insulation layer may be advantageous.

For example, a weight average molecular weight of the binder may be in a range of about 30,000 g/mol to about 1,000,000 g/mol, about 40,000 g/mol to about 900,000 g/mol, or about 50,000 g/mol to about 850,000 g/mol. Within the above range, desired or improved insulation may be effectively secured, and the weight average molecular weight of the binder may be advantageous in securing the effect of reducing or suppressing the occurrence of curls and burrs in the insulation layer.

For example, a size of a burr generated in the insulation layer may be about 50% or less of a thickness of the tab portion. If (when) the above condition is satisfied, the effect of introducing an insulation layer according to some example embodiments may be improved or maximized.

For example, the thickness of the insulation layer may be in a range of about 50% to about 300%, about 70% to about 250%, or about 90% to about 260% relative to the thickness of the tab portion. Within the above range, the insulation property by the insulation layer may be improved, and at the same time, the occurrence of curls and burrs in the insulation layer may be effectively reduced or suppressed. For example, the thickness of the insulation layer may be measured as the thickness of the insulation layer formed on one surface of the tab portion.

For example, a thickness of the insulation layer may be in a range of about 10% to about 65%, about 15% to about 63%, or about 20% to about 61% relative to a thickness of the electrode active material layer. Within the above range, it is possible to effectively secure insulation by the insulation layer while simultaneously or contemporaneously securing battery performance. For example, the thickness of the insulation layer may be measured by measuring the thickness of the insulation layer formed on one surface of the tab portion, and the thickness of the electrode active material layer may be measured by measuring the thickness of the electrode active material layer formed on one surface of the current collector.

For example, the inorganic filler may include at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, AlO(OH) (boehmite), or a combination thereof. When the above is satisfied, by introducing an inorganic filler into the insulation layer on the tab portion, the inorganic filler may constitute a pillar that receives stress generated within the insulation layer, thereby alleviating internal stress and effectively reducing or suppressing the occurrence of curls and burrs. In addition, the inorganic filler introduced into the insulation layer may constitute a support, thereby increasing the thickness of the insulation layer, which may also be effective in reducing or preventing burrs from providing on the electrode. In addition, even if (when) the thickness of the insulation layer increases, the inorganic filler within the insulation layer may be substantially uniformly distributed, and even if (when) a burr occurs, the occurrence of a short circuit of the electrode may be reduced or suppressed, which may be advantageous in securing the stability of the battery.

Meanwhile, in the case of an insulation layer that does not include an inorganic filler, flowing may occur and the thickness may also be formed to be low. In addition, there is no component that constitutes a pillar within the insulation layer, and the anisotropic form of the binder causes an internal stress difference within the insulation layer, which may readily cause curling.

For example, an average particle diameter D₅₀ of the inorganic filler may be in a range of about 1 μm to about 10 μm, about 2 μm to about 8 μm, or about 2 μm to about 5 μm. Within the above range, the inorganic filler may effectively constitute a pillar that receives stress generated within the insulation layer, thereby reducing or suppressing the occurrence of curls and burrs and increasing the thickness.

For example, the electrode may be at least one of a positive electrode and a negative electrode. Accordingly, when the electrode is a positive electrode, the electrode current collector may be a positive electrode current collector, and the electrode active material layer may be a positive electrode active material layer. In this case, the descriptions of the positive electrode described below may be equally applied to the positive electrode current collector and the positive electrode active material. Likewise, when the electrode is a negative electrode, the electrode current collector may be a negative electrode current collector, and the electrode active material layer may be a negative electrode active material layer. In this case, the descriptions of the negative electrode described below may be equally applied to the negative electrode current collector and the negative electrode active material layer. For example, the electrodes may be both positive electrode and negative electrode, and in such cases, the following descriptions regarding positive and negative electrodes may apply.

A rechargeable lithium battery according to some example embodiments includes the aforementioned positive electrode, a negative electrode, and an electrolyte solution. For example, a rechargeable lithium battery may include a positive electrode, a negative electrode, a separator between the positive electrode and the negative electrode, and an electrolyte solution.

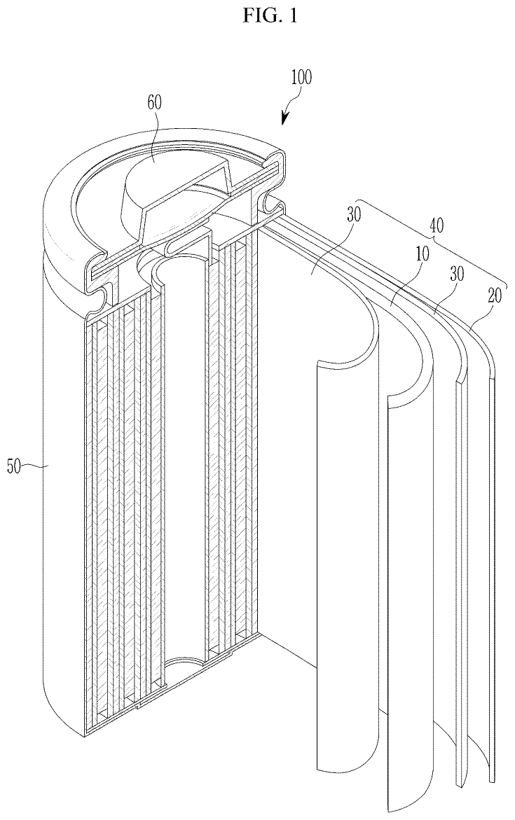

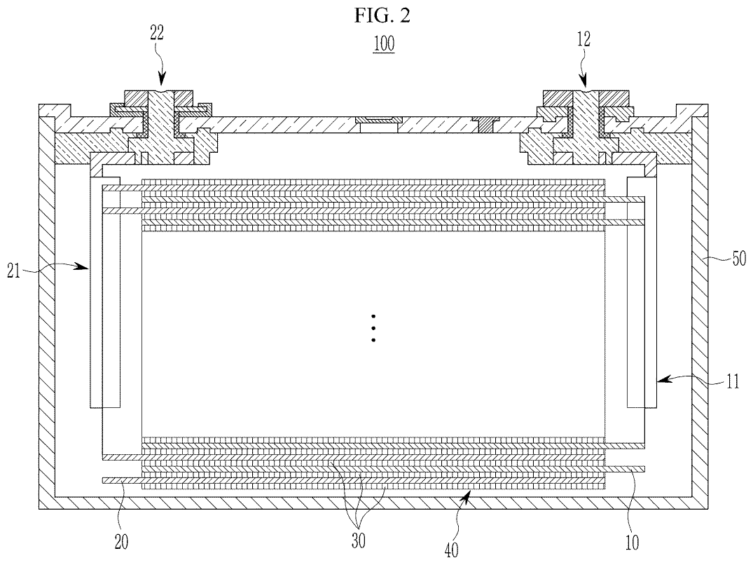

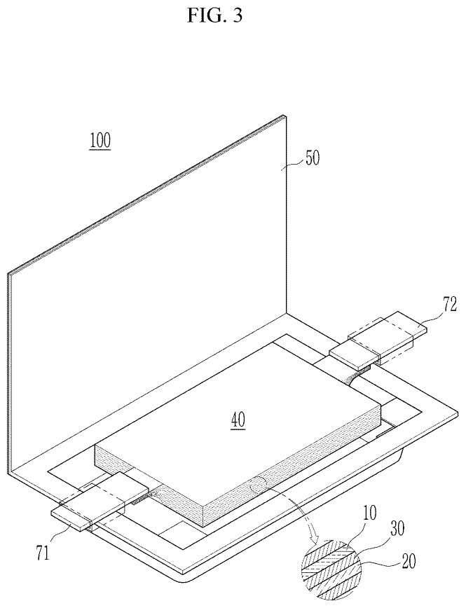

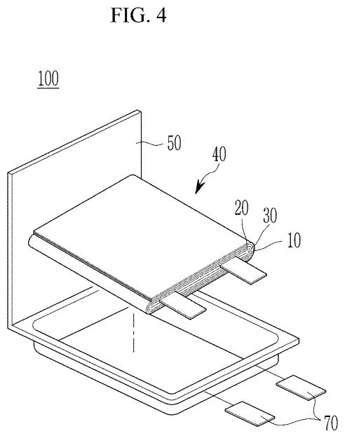

The rechargeable lithium battery may be classified into cylindrical, prismatic, pouch, coin, and the like, depending on the shape. FIG. 1 to FIG. 4 are schematic views showing the rechargeable lithium battery according to some example embodiments, where FIG. 1 is a cylindrical battery, FIG. 2 is a prismatic battery, and FIG. 3 and FIG. 4 are a pouch-shaped battery. Referring to FIG. 1 to FIG. 4, a rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 3 and FIG. 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electric path for inducing the current formed in the electrode assembly 40 to the outside of the rechargeable lithium battery 100.

### Positive Electrode

The positive electrode includes a positive electrode current collector, and a positive electrode active material layer on the positive electrode current collector. The positive electrode active material layer may further include a binder, a conductive material, or a combination thereof.

### Positive Electrode Active Material

The positive electrode active material may be or include a compound capable of reversibly intercalating and deintercalating lithium (lithiated intercalation compound). For example, at least one or more of a composite oxide of lithium and a metal such as or including at least one of cobalt, manganese, nickel, and a combination thereof, may be used.

The composite oxide may be or include a lithium transition metal composite oxide, and examples thereof may include at least one of lithium nickel-based oxide, lithium cobalt-based oxide, lithium manganese-based oxide, a lithium iron phosphate-based compound, cobalt-free lithium-nickel-manganese-based oxide, lithium-rich layered oxide, or a combination thereof.

For example, the positive electrode active material may be or include a high-nickel positive electrode active material in which a nickel content is greater than or equal to about 80 mol % based on 100 mol % of metals excluding lithium in a lithium transition metal composite oxide. In the high-nickel positive electrode active material, the nickel content may be greater than or equal to about 85 mol %, greater than or equal to about 90 mol %, greater than or equal to about 91 mol %, or greater than or equal to about 94 mol %, and less than or equal to about 99 mol %, based on 100 mol % of the metal excluding lithium. The high-nickel positive electrode active materials may achieve high capacity and may be applied to high-capacity, high-density rechargeable lithium batteries.

As another example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤C≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; Q is or includes at least one of Ti, Mo, Mn, or a combination thereof; Z is or includes at least one of Cr, V, Fe, Sc, Y, or a combination thereof; and L¹ is or includes at least one of Mn, Al, or a combination thereof.

### Binder

The binder improves binding properties of positive electrode active material particles with one another, and with a current collector. Examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, or nylon, but are not limited thereto.

### Conductive Material

The conductive material is included to provide electrode conductivity, and any electrically conductive material may be used as a conductive material unless the conductive material causes an adverse chemical change in the battery. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

Each amount of the binder and the conductive material may be in a range of about 0.5 wt % to about 5 wt %, based on 100 wt % of the positive electrode active material layer.

The positive electrode current collector may include Al foil, but the positive electrode current collector is not limited thereto.

### Negative Electrode

The negative electrode may include a current collector and a negative electrode active material layer on the current collector, and the negative electrode active material layer may include a negative electrode active material, and may further include a binder, a conductive material, or a combination thereof.

### Negative Electrode Active Material

The negative electrode active material may include at least one of a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof, for example at least one of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof), or a combination thereof. The Sn-based negative electrode active material may be or include at least one of Sn, SnO₂, a Sn alloy, or a combination thereof.

The silicon-carbon composite may be or include a composite of silicon and amorphous carbon. An average particle diameter (D₅₀) of the silicon-carbon composite particles may be, for example, in a range of about 0.5 μm to about 20 μm. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include artificial graphite, natural graphite, or a combination thereof. The amorphous carbon may include soft carbon or hard carbon, a mesophase pitch carbonized product, and calcined coke.

If (when) the silicon-carbon composite includes silicon and amorphous carbon, an amount of silicon may be in a range of about 10 wt % to about 50 wt %, and an amount of amorphous carbon may be in a range of about 50 wt % to about 90 wt % based on 100 wt % of the silicon-carbon composite. In addition, if (when) the composite includes silicon, amorphous carbon, and crystalline carbon, an amount of silicon may be in a range of about 10 wt % to about 50 wt %, an amount of crystalline carbon may be in a range of about 10 wt % to about 70 wt %, and an amount of amorphous carbon may be in a range of about 20 wt % to about 40 wt % based on 100 wt % of the silicon-carbon composite.

For example, a thickness of the amorphous carbon coating layer may be in a range of about 5 nm to about 100 nm. An average particle diameter (D₅₀) of the silicon particles (primary particles) may be in a range of about 10 nm to about 1 μm, or about 10 nm to about 200 nm. The silicon particles may be present as silicon alone, in the form of a silicon alloy, or in an oxidized form. The oxidized form of silicon may be represented by SiOₓ (0<x≤2). For example, the atomic content ratio of Si:O, which indicates a degree of oxidation, may be in a range of about 99:1 to about 33:67. As used herein, when a definition is not otherwise provided, an average particle diameter (D₅₀) indicates a diameter of a particle where a cumulative volume is about 50 volume % in a particle size distribution.

The Si-based negative electrode active material or Sn-based negative electrode active material may be mixed with the carbon-based negative electrode active material. When the Si-based negative electrode active material or the Sn-based negative electrode active material, and the carbon-based negative electrode active material, are mixed together, the mixing ratio may be a weight ratio in a range of about 1:99 to about 90:10.

### Binder

The binder adheres the negative electrode active material particles to each other, and adheres the negative electrode active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, at least one or more of carboxymethyl cellulose, hydroxypropylmethyl cellulose, methyl cellulose, or alkali metal salts thereof may be mixed and used. The alkali metal may be or include at least one of Na, K, or Li.

The dry binder may be or include a polymer material capable of becoming a fiber, and may be or include, for example, at least one of polytetrafluoroethylene, polyvinylidene fluoride, a vinylidene fluoride-hexafluoropropylene copolymer, polyethylene oxide, or a combination thereof.

### Conductive Material

The conductive material is included to provide electrode conductivity, and any electrically conductive material may be used as a conductive material unless the electrically conductive material causes an adverse chemical change in the battery. Examples of the conductive material include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

An amount of the negative electrode active material may be in a range of about 95 wt % to about 99.5 wt % based on 100 wt % of the negative electrode active material layer, and an amount of the binder may be in a range of about 0.5 wt % to about 5 wt % based on 100 wt % of the negative electrode active material layer. For example, the negative electrode active material layer may include a range of about 90 wt % to about 99 wt % of the negative electrode active material, a range of about 0.5 wt % to about 5 wt % of the binder, and a range of about 0.5 wt % to about 5 wt % of the conductive material.

### Negative Electrode Current Collector

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be, for example, in a range of about 1 μm to about 20 μm, about 5 μm to about 15 μm, or about 7 μm to about 10 μm.

### Electrolyte

For example, the electrolyte for a rechargeable lithium battery may be or include an electrolyte solution, which may include a non-aqueous organic solvent and a lithium salt.

The non-aqueous organic solvent constitutes a medium for transmitting ions taking part in the electrochemical reaction of a battery. The non-aqueous organic solvent may be or include at least one of a carbonate-based, ester-based, ether-based, ketone-based, alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, and may include a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvent may be used alone, or in a mixture of two or more types of solvents, and when two or more types are used in a mixture, a mixing ratio can be adjusted as desired according to the desired battery performance, which is widely known to those working in the field.

When using a carbonate-based solvent, a cyclic carbonate and a chain carbonate may be mixed together, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be mixed together in a volume ratio in a range of about 1:1 to about 30:1.

The electrolyte solution may further include at least one of vinylethyl carbonate, vinylene carbonate, or an ethylene carbonate-based compound to improve battery cycle-life.

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, and the like.

The lithium salt dissolved in the organic solvent supplies lithium ions in a battery, enables an operation of a rechargeable lithium battery, and improves transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

A concentration of lithium salt may be within the range of about 0.1 M to about 2.0 M. If (when) the concentration of lithium salt is within the above range, the electrolyte solution has desired ionic conductivity and viscosity, and thus desired or improved performance can be achieved and lithium ions can move effectively.

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one surface, or on both surfaces of the porous substrate.

The porous substrate may be or include a polymer film formed of or including any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (e.g., TEFLON®), or a copolymer or mixture of two or more thereof.

The porous substrate may have a thickness in a range of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. An average particle diameter (D₅₀) of the inorganic particles may be in a range of about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked together.

The thickness of the coating layer may be in a range of about 0.5 μm to about 20 μm, for example, about 1 μm to about 10 μm, or about 1 μm to about 5 μm.

Examples and comparative examples of the present disclosure are described below. However, the following examples are only examples of the present disclosure, and the present disclosure is not limited to the following examples.

### Example 1

### (1) Manufacturing of Positive Electrode

96 wt % of LiCoO₂, 2 wt % of Ketjen black, and 2 wt % of polyvinylidene fluoride were mixed in an N-methyl pyrrolidone (NMP) solvent to prepare a slurry for a positive electrode active material layer. The slurry for a positive electrode active material layer was coated on both surfaces of an about 10 μm-thick aluminum foil as a positive electrode current collector, and then dried and compressed to form each positive electrode active material layer with a thickness of about 41.5 μm on both surfaces of the positive electrode current collector.

Subsequently, a composition for an insulation layer was prepared by mixing polyimide (model name: WPI-100, Manufacturer: Komac, weight average molecular weight: 200,000 g/mol), and boehmite particles (D₅₀: 2.77 μm) in a weight ratio of 25:75 in an NMP solvent. Herein, the composition for an insulation layer was adjusted to have a solid content of 28.71 wt % and a viscosity of 2032 cP.

Subsequently, the composition for an insulation layer was coated on the side surfaces of the positive electrode active material layer and both surfaces of the aluminum foil, and then dried at 90° C. Through the above, on the side surfaces of the positive electrode active material layer and both surfaces of the aluminum foil, each insulation layer with a thickness of about 12 μm was formed.

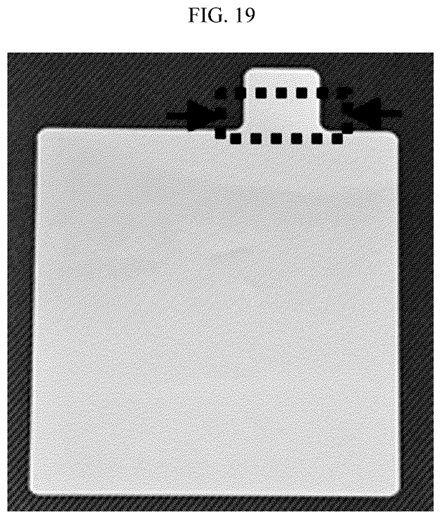

Subsequently, as shown in the dotted square of FIG. 19, a tab portion was cut by punching and notching, obtaining a positive electrode in which each positive electrode active material layer was formed on both surfaces of the positive electrode current collector, and each insulation layer was formed on both surface of the tab portion connected to the positive electrode current collector.

### (2) Manufacturing of Negative Electrode

97.5 wt % of an artificial graphite negative electrode active material, 1 wt % of carboxymethyl cellulose (CMC), and 1.5 wt % of styrene butadiene rubber (SBR) were mixed in a water solvent to prepare a slurry for a negative electrode active material layer. The slurry for a negative electrode active material layer was coated on a copper foil, and then dried and compressed to form a negative electrode active material layer on the negative electrode current collector, thereby manufacturing a negative electrode.

### (3) Manufacturing of Rechargeable Lithium Battery Cell

The positive and negative electrodes were used with a polytetrafluoroethylene separator and an electrolyte solution prepared by mixing ethylene carbonate and dimethyl carbonate in a volume ratio of 3:7 and dissolving 1 M LiPF₆ in the mixed solvent to manufacture a rechargeable lithium battery cell in a common method.

### Example 2

A positive electrode and a rechargeable lithium battery cell were manufactured substantially in the same manner as in Example 1, except that the insulation layer was formed by changing the weight ratio of polyimide and boehmite particles to 37.5:62.5, adjusting the solid content and the viscosity of the composition for an insulation layer respectively to 20.74 wt % and 1679 cP, and changing the thickness to about 25 μm each on both surfaces of the tab portion.

### Example 3

A positive electrode and a rechargeable lithium battery cell were manufactured substantially in the same manner as in Example 1, except that the insulation layer was formed to have each thickness of about 25 μm on both surfaces of the tab portion.

### Example 4

A positive electrode and a rechargeable lithium battery cell were manufactured substantially in the same manner as in Example 1, except that the insulation layer was formed by changing the weight ratio of polyimide and boehmite particles to 20:80 and the thickness to about 25 μm each on both surfaces of the tab portion.

### Example 5

A positive electrode and a rechargeable lithium battery cell were manufactured substantially in the same manner as in Example 1, except that the insulation layer was formed by changing the weight ratio of polyimide and boehmite particles to 15:85 and the thickness to about 25 μm each on both surfaces of the tab portion.

### Example 6

A positive electrode and a rechargeable lithium battery cell were manufactured substantially in the same manner as in Example 1, except that the insulation layer was formed by changing the weight ratio of polyimide and boehmite particles to 10:90 and the thickness to about 25 μm each on both surfaces of the tab portion.

### Example 7

A positive electrode and a rechargeable lithium battery cell were manufactured substantially in the same manner as in Example 1, except that the insulation layer was formed to have each thickness of about 14 μm on both surfaces of the tab portion.

### Example 8

A positive electrode and a rechargeable lithium battery cell were manufactured substantially in the same manner as in Example 3, except that the insulation layer was formed by using poly amide (model name: PA-100, manufacturer: Komac weight average molecular weight: 50,000 g/mol) instead of the polyimide as the binder.

### Example 9

A positive electrode and a rechargeable lithium battery cell were manufactured substantially in the same manner as in Example 1, except that the insulation layer was formed by changing the weight ratio of polyimide and boehmite particles to 50:50, adjusting the solid content and the viscosity of the composition for an insulation layer respectively to 17.36 wt % and 1639 cP, and changing the thickness to about 25 μm each on both surfaces of the tab portion.

### Example 10

A positive electrode and a rechargeable lithium battery cell were manufactured substantially in the same manner as in Example 3, except that the insulation layer was formed by using alumina particles instead of the boehmite particles.

### Comparative Example 1

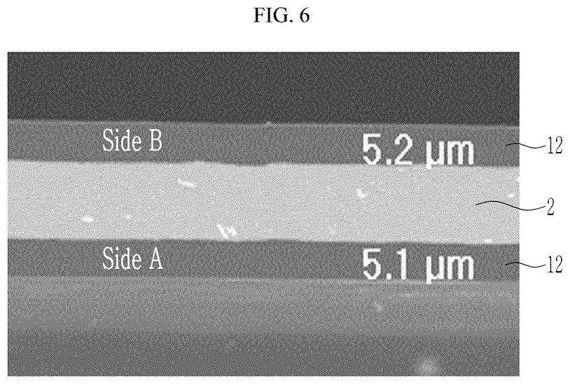

A positive electrode and a rechargeable lithium battery cell were manufactured substantially in the same manner as in Example 1, except that the insulation layer was formed by not using the boehmite particles and changing the thickness to about 5.1 μm and 5.2 μm each on both surfaces (Sides A and B of FIG. 6) of the tab portion, as shown in FIG. 6.

### Comparative Example 2

A positive electrode and a rechargeable lithium battery cell were manufactured substantially in the same manner as in Example 3, except that the insulation layer was formed by using polyvinylidene fluoride (manufacturer: Solvay, model name: Solef 5130, weight average molecular weight: 600,000 g/mol) instead of the polyimide as the binder.

### Comparative Example 3

A positive electrode and a rechargeable lithium battery cell were manufactured substantially in the same manner as in Example 3, except that the insulation layer was formed by using polyvinylidene fluoride (manufacturer: Solvay, model name: Solef 6020, weight average molecular weight: 670,000 g/mol) instead of the polyimide as the binder and alumina particles instead of the boehmite particles as the inorganic filler.

### Comparative Example 4

A positive electrode and a rechargeable lithium battery cell were manufactured substantially in the same manner as in Comparative Example 2, except that the insulation layer was formed by not using the boehmite particles as the inorganic filler.

### Evaluation Example 1: Scanning Electron Microscope (SEM) Evaluation

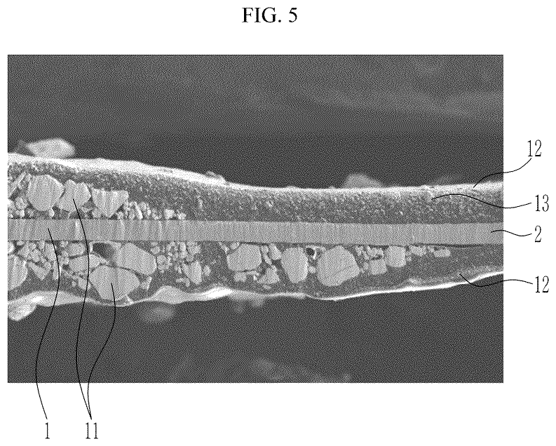

Cross-sectional images of the positive electrodes of Example 1 and Comparative Example 1 were taken with a scanning electron microscope (SEM), and the image results are respectively shown in FIG. 5 and FIG. 6.

Looking at FIG. 6, in the case of Comparative Example 1, it was confirmed that the insulation layer 12 was formed on the tab portion 2 connected to the electrode current collector. In addition, Comparative Example 1, in which polyimide alone was introduced as the binder into the insulation layer 12, was confirmed that the insulation layer was somewhat thinner than the insulation layer of Example 1.

Looking at FIG. 5, Example 1 was confirmed that the electrode active material layer 11 was formed on the electrode current collector 1, and the insulation layer 12 was formed on the tab portion 2 connected to the electrode current collector 1. Example 1, in which the inorganic filler 13 in addition to the polyimide as a binder was additionally introduced into the insulation layer 12, was confirmed that the insulation layer 12 was somewhat thicker than the insulation layer of Comparative Example 1. In addition, the inorganic filler 13 was confirmed to be substantially evenly distributed inside the insulation layer 12 of Example 1.

### Evaluation Example 2: Evaluation of Curl Generation Level According to Amount of Binder and Inorganic Filler in Insulation Layer

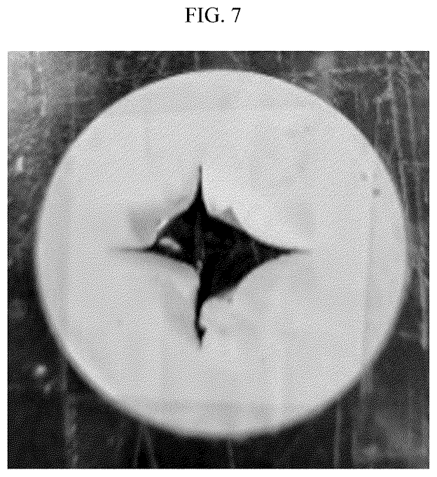

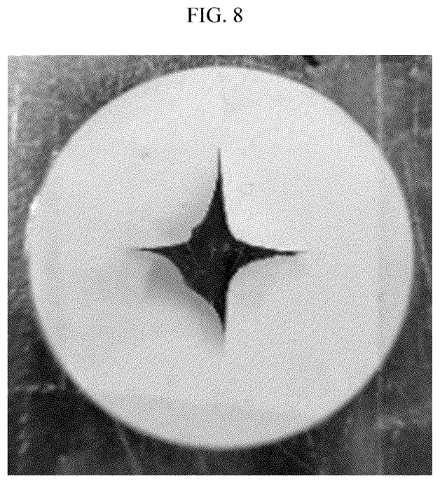

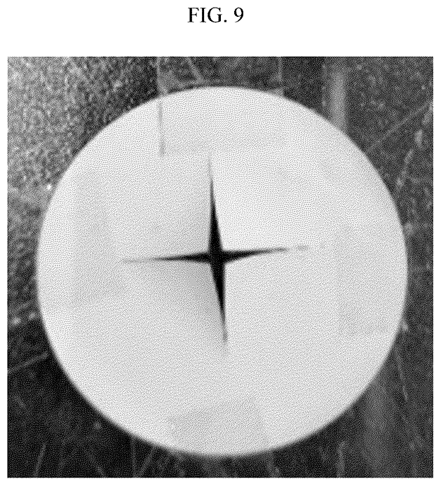

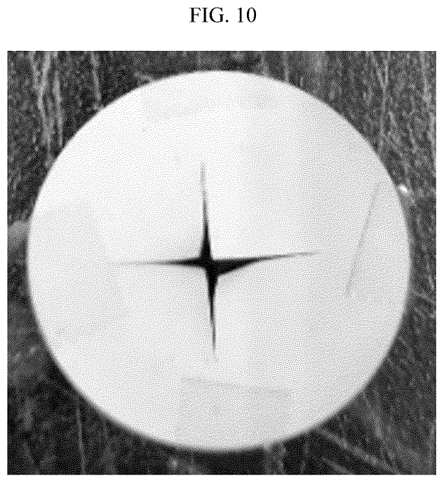

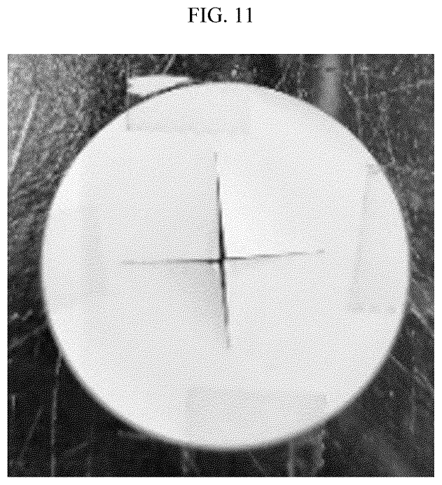

In order to compare curling levels according to content variations of the binder and the inorganic filler in the insulation layers having the same thickness, after cutting out circular samples of the positive electrodes of Examples 2 to 6, whose insulation layers had the same thickness of about 25 μm, in a cross shape at the center, and then heat-treating the insulation layers at 90° C., the image results are respectively shown in FIG. 7 to FIG. 11.

Referring to FIG. 7 to FIG. 11, in the insulation layers of the positive electrodes of Examples 2 to 6, the more inorganic filler, the less curls, which confirmed that the curl-suppressing effect was improved.

In particular, in the insulation layers of the positive electrodes, Examples 3 to 6, which included 75 wt % to 90 wt % of the inorganic filler based on 100 wt % of a total of the binder and the inorganic filler, were confirmed to exhibit the more desired or improved curl-suppressing effect than Example 2.

In addition, in the insulation layers of the positive electrodes, Examples 4 to 6, which included 80 wt % to 90 wt % of the inorganic filler based on 100 wt % of the total of the binder and the inorganic filler, were confirmed to exhibit the more desired or improved curl-suppressing effect than Examples 2 and 3.

### Evaluation Example 3: Evaluation of Curl Occurrence Level According to Thickness of Insulation Layer

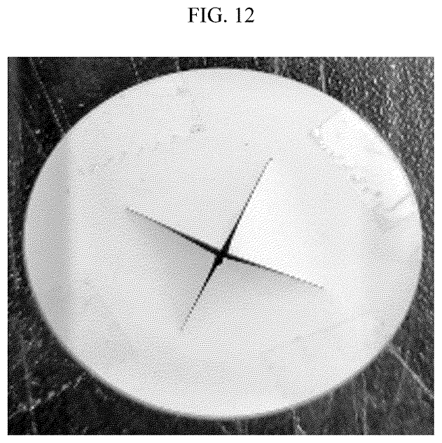

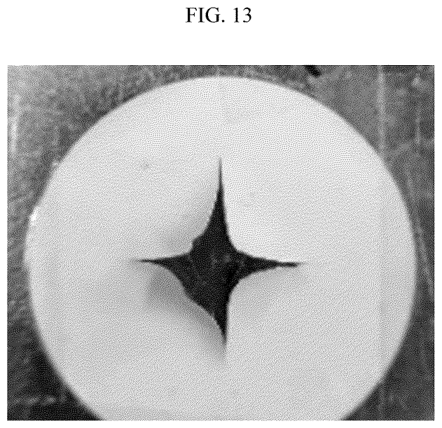

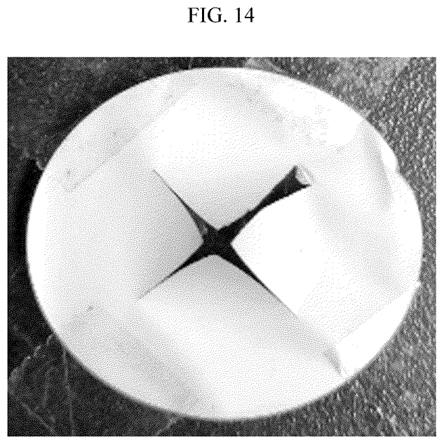

In order to compare curling levels according to thickness changes of the insulation layers having the same composition, the circular samples of the positive electrodes of Examples 1, 3, and 7 having the same weight ratio of 25:75 between binder and inorganic filler were cut out in a cross shape at the center, and then heat-treated at 90° C., and the image results are respectively shown in FIG. 12 to FIG. 14.

In addition, the circular samples of the positive electrodes of Examples 1, 3, and 7 were measured with respect to a height of the curls occurred in the above evaluation, and the results are shown in Table 1 below.

TABLE 1

| Example 1 | Example 3 | Example 7 |
|---|---|---|
| 2.5 mm | 5.0 mm | 3.5 mm |

Referring to FIG. 12 to FIG. 14 and Table 1, in the insulation layers of the positive electrodes of Examples 1, 3, and 7, the thicker insulation layer, the more curls, which confirmed that the curl-suppressing effect was reduced.

Accordingly, based on the insulation layers with the same composition, the thinner insulation layer, the better curl-suppressing effect.

In addition, the thicker insulation layers, the more difficult it becomes to reduce or suppress the curl occurrence, which may require a higher-level precise control for reducing or suppressing the curl occurrence in the insulation layers.

### Evaluation Example 4: Evaluation of Curl Occurrence Level According to Type of Binder in Insulation Layer

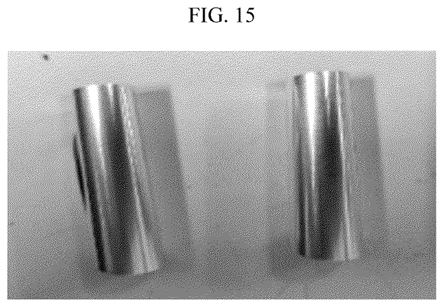

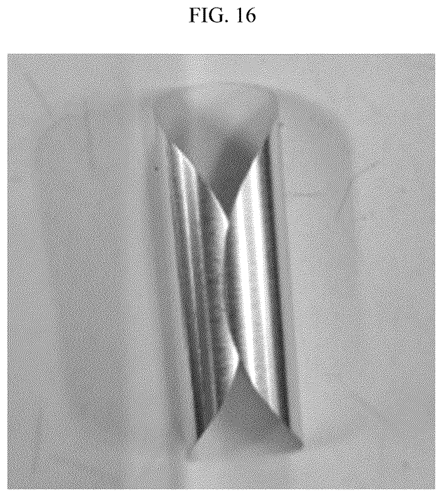

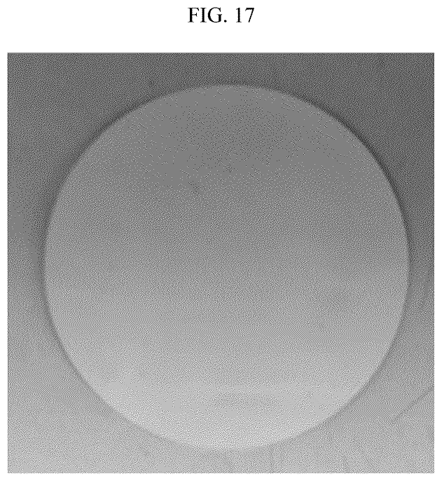

The compositions for an insulation layer according to Examples 3 and 8 and Comparative Example 2 were respectively coated to be about 25 μm thick on an aluminum foil, and then dried to obtain circular samples, which were heat-treated at 100° C., and image results thereof are respectively shown in FIG. 15 to FIG. 17.

Referring to FIG. 15 to FIG. 17, compared to Comparative Example 2 using polyvinylidene fluoride as the binder in the insulation layer, Examples 3 and 8 using polyimide and poly amide as the binder in each insulation layer were confirmed to exhibit desired or improved insulation performance by using the binder with desired or improved insulation property, but curls more readily occurred in Examples 3 and 8 than in Comparative Example 2.

Accordingly, in order to effectively work as an insulation layer while reducing or suppressing the curl occurrence, a higher-level precise control than the insulation layer of Comparative Example 2 using polyvinylidene fluoride as the binder of the insulation layer may be advantageous.

### Evaluation Example 5: Uniformity Evaluation

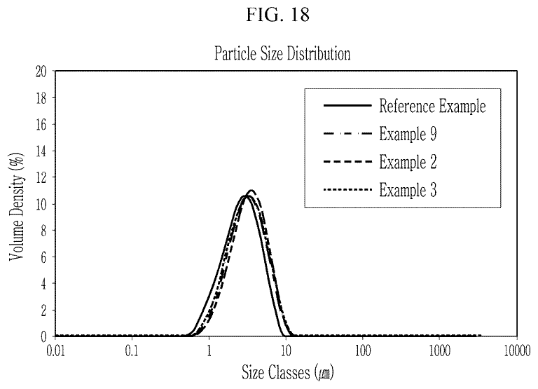

In order to evaluate uniformity of the insulation layers of Examples 2, 3, and 9, the compositions for an insulation layer according to Examples 2, 3, and 9 were analyzed with respect to particle distributions by using a particle size analyzer, and the analysis results are shown in FIG. 18.

In addition, a composition for an insulation layer as a reference example was prepared substantially in the same manner as in Example 3, except that the boehmite particles as the inorganic filler without using the binder were used and subjected to particle distribution analysis, and the results are shown in FIG. 18.

In addition, the boehmite particles used as the inorganic filler in the reference example and Examples 2, 3, and 9 were measured with respect to a specific surface area (SSA) and an average particle diameter (D₅₀), and the results are shown in Table 2 below.

TABLE 2

| | SSA (m²/kg) | D₅₀ (μm) |
|---|---|---|
| Reference Example | 2696 | 2.68 |
| Example 2 | 2139 | 3.32 |
| Example 3 | 2284 | 3.11 |
| Example 9 | 2262 | 3.12 |

Referring to FIG. 18 and Table 2, compared to the composition for an insulation layer using the inorganic filler without using the binder according to the reference example, Examples 2, 3, and 9, which compositions for an insulation layer were prepared by using the inorganic filler with the binder but in each different ratio, were confirmed to exhibit similar particle distributions to the particle distribution of the reference example.

When the binder in addition to the inorganic filler was additionally used to prepare the compositions for an insulation layer, as a result of examining whether or not uniformity of components was deteriorated, a similar particle distribution was obtained to when the binder was not used, which confirmed that the inorganic filler was neither coagulated nor nonuniformly present but uniformly dispersed in the composition for an insulation layer.

Accordingly, the insulation layers formed by using the compositions for an insulation layer according to Examples 2, 3, and 9 were expected to have components that were uniformly distributed.

### Evaluation Example 6: Evaluation of Burr Occurrence Level

As with each of the positive electrodes according to Example 3 and Comparative Example 1, two F/C (Full Cathode) samples were prepared respectively for Example 3 and Comparative Example 1, in which a positive electrode active material layer was formed on both sides of a positive electrode current collector, and an insulation layer was formed on both surfaces of a tab portion connected to the positive electrode current collector.

Additionally, two H/C (Half Cathode) samples of Example 3 and Comparative Example 1 was prepared by manufacturing each positive electrode substantially in the same manner as in Example 3 and Comparative Example 1, except that the positive electrode active material layer was formed on one surface of the positive electrode current collector, and the insulation layer was formed on one surface of the tab portion connected to the positive electrode current collector (and a side surface of the positive electrode active material layer).

Herein, an aluminum foil used in the samples had the same thickness as the thickness of a tab portion shown in Table 3 below.

Subsequently, the F/C (Full Cathode) and H/C (Half Cathode) samples according to Example 3 and Comparative Example 1 were punched and notched to form a tab portion as performed in Example 3, and after checking whether or not burrs occurred, the burrs was measured with respect to a size through VM (Virtual Microscopy), and the results are shown in Table 3 below.

TABLE 3

| | | H/C | | F/C | |
|---|---|---|---|---|---|
| Example 3 | Burr size [μm] | 6.16 | 5.39 | 3.75 | 4.89 |
| | Thickness of tab portion [μm] | 18.44 | 20.34 | 9.75 | 10.32 |
| Comparative | Burr size [μm] | 8.33 | 12.43 | 6.78 | 7.48 |
| Example 1 | Thickness of tab portion [μm] | 14.96 | 13.76 | 10.97 | 9.66 |

Referring to Table 3 above, Example 3, in which the inorganic filler in addition to the binder was introduced into the composition for an insulation layer, was confirmed that the burrs occurred in the insulation layer had a size satisfying 50% or less of the thickness of the tab portion in all the samples.

Accordingly, Example 3, in which the burrs occurred by the punching had a smaller size than the burrs of Comparative Example 1, was confirmed to exhibit the desired or improved burr-suppressing effect.

### Evaluation Example 7: Evaluation of Electrolyte Solution Swelling Degree, Peeling Ability, and Discoloration after Electrolyte Solution Impregnation

The circular samples of the positive electrodes of Examples 3 and 10 and Comparative Examples 1 to 4 were impregnated in an electrolyte solution at 60° C. for 12 hours, and then evaluated with respect to an electrolyte solution swelling degree, peeling ability, and discoloration after the electrolyte solution impregnation, and the results are shown in Table 4 below.

Herein, the electrolyte solution was prepared by dissolving 1 M LiPF₆ in a mixed solvent of ethylene carbonate and dimethyl carbonate mixed in a volume ratio of 3:7.

The electrolyte solution swelling degree was measured by taking out each impregnated circular sample in the electrolyte solution, and then sufficiently and quickly wiping the sample to measure the weight thereof in the following method.

Swelling degree=weight of circular sample after electrolyte impregnation÷a weight of the circular sample before the electrolyte impregnation

In addition, the peeling ability after the electrolyte solution impregnation was evaluated by taking out each of the impregnated circular samples in the electrolyte solution, attaching a double-sided adhesive tape to the circular sample, and peeling off the double-sided adhesive tape therefrom to evaluate whether the insulation layer was separated or not.

In addition, whether or not there was discoloration after the electrolyte solution impregnation was evaluated by examining whether or not there was discoloration with the naked eye after taking out the impregnated circular samples.

TABLE 4

| | Electrolyte | Whether or not there | Whether or not there |
|---|---|---|---|
| | solution | is peeling after | is discoloration after |
| | swelling | electrolyte solution | electrolyte solution |
| | degree | impregnation | impregnation |
| Example 3 | 1.05 | Maintaining adhesion | No |
| Example 10 | 1.07 | Maintaining adhesion | No |
| Comparative | 1.80 | Maintaining adhesion | No |
| Example 1 | | | |
| Comparative | 1.02 | Complete peeling | No |
| Example 2 | | | |
| Comparative | 1.03 | Complete peeling | No |
| Example 3 | | | |
| Comparative | 1.80 | Complete peeling | No |
| Example 4 | | | |

Referring to Table 4 above, the circular samples prepared by using the inorganic filler with polyimide as the binder according to Examples 3 and 10 were confirmed to exhibit a low electrolyte solution swelling degree, maintain a binding state after electrolyte solution impregnation, and exhibit no electrolyte discoloration.

On the other hand, Comparative Examples 1 to 4 were confirmed to exhibit a high electrolyte solution swelling degree and peeling without maintaining the binding state after the electrolyte solution impregnation.

### Evaluation Example 8: Evaluation of Insulation Breakdown Voltage and Curl Occurrence

The circular samples of the positive electrodes of Examples 3 and 10 and Comparative Examples 1 to 4 were measured with respect to insulation property (breakdown voltage (BDV)), and simultaneously or contemporaneously examined with respect to curl occurrence, and the results are shown in Table 5 below. Herein, BDV was measured by placing each of the circular samples between SUS plates and measure a voltage where the voltage did no more increase (short circuit), while increasing the voltage to 0.5 KV at a voltage increase rate of 8 sec, after fixing a current to 0.3 mA in an AC mode by using TOS5301 made by KIKISUI.

TABLE 5

| | Insulation breakdown | |
|---|---|---|
| | voltage (kV) | Curl occurrence |
| Example 3 | 2.5 | Weak curl occurrence |
| Example 10 | 1.3 | Weak curl occurrence |
| Comparative Example 1 | 2.5 | Strong curl occurrence |
| Comparative Example 2 | 0.6 | No curl occurrence |
| Comparative Example 3 | 0.7 | No curl occurrence |
| Comparative Example 4 | 1.2 | No curl occurrence |

Referring to Table 5, the circular samples of Examples 3 and 10 using polyimide as the binder with the inorganic filler were confirmed to exhibit no strong curls as well as a desired or improved insulation property due to a sufficiently high insulation breakdown voltage, which confirmed that there was a curl-suppressing effect.

On the other hand, Comparative Example 1 using polyimide alone as the binder without using the inorganic filler was confirmed to exhibit a desired or improved insulation breakdown voltage and strong curls, which confirmed that there was a little low curl-suppressing effect.

In addition, Comparative Examples 2 to 4 using polyvinylidene fluoride rather than the polyimide as the binder were confirmed to exhibit a desired or improved curl-suppressing effect but a somewhat low insulation property due to a low insulation breakdown voltage.

### Evaluation Example 9: Flexibility Evaluation

Flexibility was evaluated by coating each of the compositions for an insulation layer of Example 3 and Comparative Example 2 on an aluminum foil, and then drying the insulation layer to prepare samples and conducting a 90° bending test to check whether cracks occurred or not after the bending test with a scanning electron microscope (SEM), and the results are shown in Table 6 below.

TABLE 6

| | Whether cracks occur |
|---|---|
| Example 3 | Cracks do not occur |
| Comparative Example 2 | Cracks occur |

Referring to Table 6 above, Example 3 exhibited no occurrence of cracks, but Comparative Example 2 exhibited the occurrence of cracks, which confirmed that the case of using polyimide (PI) as the binder like Example 3 exhibited desired or improved flexibility, compared with the case of using polyvinylidene fluoride (PVDF) like Comparative Example 2.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the appended claims.

Description of Symbols

| | |
|---|---|
| 1: electrode current collector | 2: tab portion |
| 11: electrode active material layer | 12: insulation layer |
| 13: inorganic filler | |
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A rechargeable lithium battery, comprising:
an electrode current collector;
a tab portion extending from the electrode current collector;
an electrode active material layer on the electrode current collector; and
an insulation layer on the tab portion;
wherein the insulation layer comprises a binder and an inorganic filler, and
the binder comprises at least one of polyimide, polyamide, and a combination thereof.

2. The rechargeable lithium battery as claimed in claim 1, wherein the insulation layer comprises a range of about 10 wt % to about 50 wt % of the binder based on 100 wt % of a total of the binder and the inorganic filler.

3. The rechargeable lithium battery as claimed in claim 1, wherein the insulation layer comprises a range of about 50 wt % to about 90 wt % of the inorganic filler based on 100 wt % of a total of the binder and the inorganic filler.

4. The rechargeable lithium battery as claimed in claim 1, wherein a thickness of the insulation layer is in a range of about 5 μm to about 30 μm.

5. The rechargeable lithium battery as claimed in claim 1, wherein a weight average molecular weight of the binder is in a range of about 30,000 g/mol to about 1,000,000 g/mol.

6. The rechargeable lithium battery as claimed in claim 1, wherein a size of a burr generated in the insulation layer is about 50% or less of a thickness of the tab portion.

7. The rechargeable lithium battery as claimed in claim 1, wherein a thickness of the insulation layer is in a range of about 50% to about 300% relative to a thickness of the tab portion.

8. The rechargeable lithium battery as claimed in claim 1, wherein the insulation layer is positioned on a side of the electrode active material layer.

9. The rechargeable lithium battery as claimed in claim 1, wherein a thickness of the insulation layer is in a range of about 10% to about 65% relative to a thickness of the electrode active material layer.

10. The rechargeable lithium battery as claimed in claim 1, wherein the inorganic filler comprises at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, AlO(OH), and a combination thereof.

11. The rechargeable lithium battery as claimed in claim 1, wherein an average particle diameter D₅₀ of the inorganic filler is in a range of about 1 μm to about 10 μm.

12. The rechargeable lithium battery as claimed in claim 1, wherein the electrode comprises at least one of a positive electrode and a negative electrode.
